(19) United States
(12) Patent Application Publication
(10) Pub. No.: US 2008/0217458 A1
(43) Pub. Date: Sep. 11, 2008

(54) Hybrid vehicle sensitive seat belt retractor inertial locking system

(75) Inventors: Gunter K. Clute, Bloomfield Hills, MI (US); Robert A. Mical, Dearbom Heights, MI (US); Jon E. Burrow, Ortonville, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/713,945

(22) Filed: Mar. 5, 2007

(51) Int. Cl. B60R 22/40

(52) U.S. Cl. 242/384.6

(57) ABSTRACT

A vehicle sensitive retractor locking system which may have reduced sensitivity to Z-axis accelerations experienced during driving conditions. The locking system incorporates a ball mass which is maintained within a nest surface of a ball cage. A locking lever is provided having a pair of arms, including an upper and lower arm. The lower arm forms a support post which directly engages with the ball mass in the normal condition of the locking system. The upper arm forms an actuation rim which encircles the upper portion of the ball mass. When the ball mass is displaced within the nest surface in response to inertial forces, two locking modes are provided. First, by relieving pressure exerted by the ball against the post support as the ball is displaced, the locking lever is free to rotate into a locking condition. A secondary locking mode is provided through direct contact between the ball mass and the actuation rim of the locking lever upper arm. The control system also optionally incorporates a vertical ball restrictor which directly contacts the ball mass and restricts its upper Z-axis motion.

### FIELD OF THE INVENTION

This invention relates to an automotive occupant restraint seat belt retractor, and particularly to a vehicle sensitive control system for such a retractor.

### BACKGROUND OF THE INVENTION

Motor vehicles are frequently equipped with active occupant restraint systems such as seat belt assemblies. Seat belt assemblies typically have a lap and shoulder belt portion for restraining the occupant in the event of an impact or rollover event. To enhance the comfort and convenience provided by the seat belt system, retractors are provided which allow the belt webbing to be freely paid-out and retracted when the vehicle is not subjected to unusual acceleration forces or inclination. In the event of exposure to such forces, a retractor control system activates to lock the retractor to prevent additional pay-out (extraction) of webbing. Thus, the retractor locks in a manner to enable the seat belt webbing to restrain the occupant. Such retractor control systems take various forms. One category of such control systems are known as vehicle sensitive inertial locking systems. These systems are sensitive to acceleration forces acting on the vehicle, for example in the case of a frontal impact condition. Such devices also lock the retractor in the event of side impacts, rollovers, and when certain other forces act on the vehicle.

Another category of such retractor control systems are known as webbing sensitive control systems. These devices operate much in the manner of a centrifugal clutch and sense the rotational speed of the retractor spool, such that when extremely high angular accelerations of the retractor spool occurs associated with rapid pay-out of webbing, the control system engages to lock the retractor. This invention is related to an improved vehicle sensitive retractor inertial locking system.

As mentioned previously, vehicle sensitive retractor inertial locking systems must respond to acceleration loads acting in various axes and planes. Primarily important are impacts to the vehicle creating acceleration loads acting in the horizontal plane, such as front, rear, or side impact conditions. However, if a rollover event has occurred, it is important that the retractor lock to restrain the occupant. Typical inertial retractor locking systems utilize a pendulum or rolling ball mass to activate a locking lever which engages directly or indirectly with a ratchet wheel of the retractor webbing spool which acts as a spool lock. When acceleration loads act on the vehicle, the rolling ball mass or pendulum moves to urge the locking lever to engage with the ratchet wheel, thus locking the spool from allowing further extraction of webbing. These devices have been utilized for many decades and have proven to be reliable and effective retractor control systems.

Designers of vehicle sensitive inertial locking systems for retractors attempt to design the systems such that they lock the retractor when necessary to restrain the occupant while minimizing locking during normal driving conditions. Normal maneuvers of the vehicle, and driving up and down inclines and over bumpy roads can produce forces causing a periodic locking of the retractor. This periodic locking in normal driving conditions is undesirable from an occupant comfort and convenience viewpoint. The problems of unnecessary locking of retractors tend to be especially significant in heavy duty truck-type vehicles. These vehicles, due to their operating conditions, heavy loads, and suspension systems, tend to undergo significant jounce motion (vertical displacements) as they are driven, especially over uneven road surfaces. This motion creates accelerations in the Z-axis direction, defined as the vertical axis of the vehicle. Presently available vehicle sensitive retractor control systems generally produce undesirable locking due to normally encountered Z-axis accelerations, especially in heavy truck applications.

In view of the above, there exists on need for an improved inertia sensitive retractor control system that is less sensitive to normally encountered Z-axis accelerations while meeting other design and performance specifications.

### SUMMARY OF THE INVENTION

In satisfying the above need, as well as overcoming the enumerated drawbacks and other limitations of the related art, the present invention provides a vehicle sensitive retractor inertial locking system preferably having intentionally reduced sensitivity to normal Z-axis accelerations acting on the motor vehicle. The locking system utilizes a rolling ball mass which, when displaced, engages a locking lever to lock a seat belt retractor. In one embodiment, a mass restrictor is positioned to restrict the distance the mass may move along the Z-axis (i.e. vertically) when subject to Z-axis accelerations, preventing the mass from engaging the locking lever under such conditions. The seat belt retractor locking system in accordance with the present invention provides two distinct locking modes. The locking lever of the braking system is weighted and pivots in a manner that it is urged into a locking position by the position of its center of gravity (cg) and its pivot point. The locking lever includes an upper arm forming a “High G” actuation rim and a lower arm having a lower post support which contacts the ball mass. In some actuation conditions, such as exposure to a “low g” actuation condition, the ball mass moves within the nest surface of its ball cage to a displaced position out of contact with the locking lever lower post support. In this condition, the locking lever is free to rotate due to the position of its cg and pivot point to an engaged position, thereby locking the retractor. In a “High G” actuation condition where fast response is required, the displacement of the ball mass directly engages the actuation rim formed by the upper locking lever arm. This interaction directly forces the locking lever to move into an engaged position.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a side view of a seat belt retractor inertial locking system in accordance with the present invention;

FIG. 2 is a pictorial view of the seat belt retractor locking system illustrated in FIG. 1;

FIG. 3 is a side view similar to FIG. 1 showing the ball mass displaced to allow engagement of the locking lever; and

FIG. 4 is a pictorial view of the locking system similar to FIG. 2 but showing the locking lever removed.

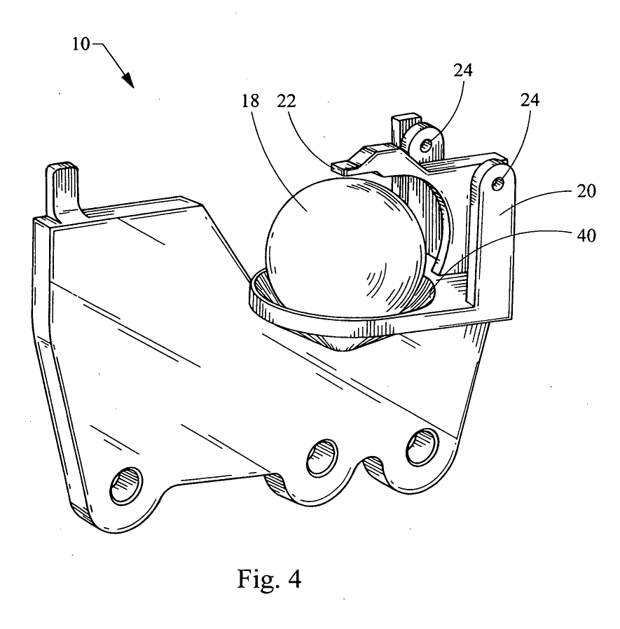

### DETAILED DESCRIPTION OF THE INVENTION

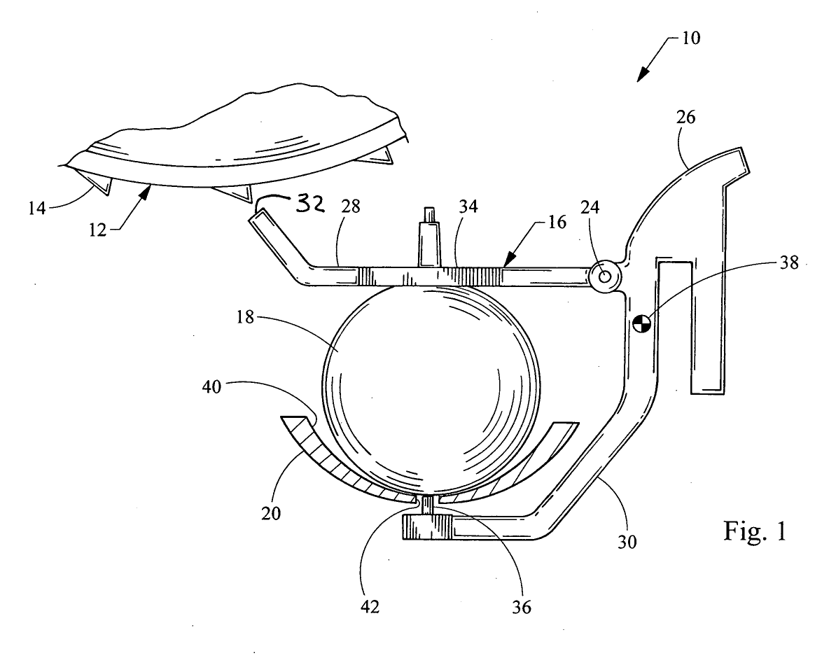

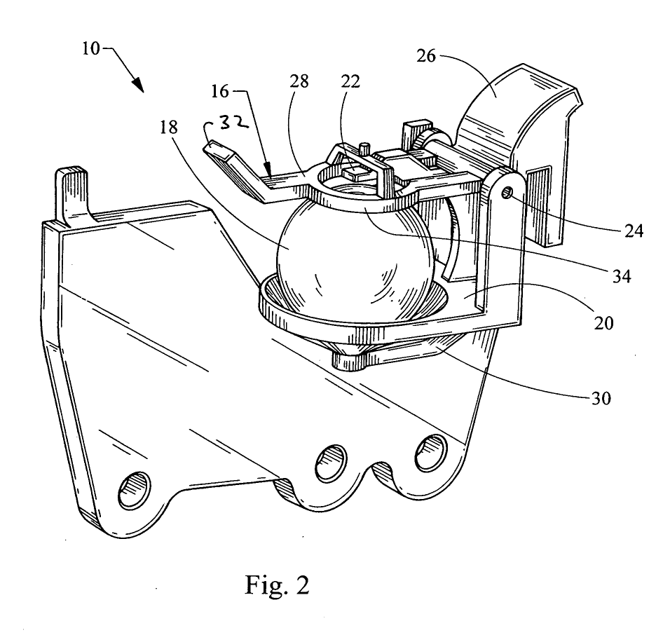

A seat belt retractor inertial locking system in accordance with the present invention is illustrated in FIGS. 1 and 2 and is generally designated by reference number 10. Locking system 10 is engaged with a ratchet wheel 12 which is part of a seat belt retractor (not shown in entirety) having a rotating webbing spool. Ratchet wheel 12 includes an array of ramped teeth 14 around its perimeter. These teeth 14 are used to enable the locking system 10 to lock the webbing retractor spool, restricting extraction of seat belt webbing under specific operating conditions. Locking system 10 primarily incorporates locking lever 16, ball mass 18, ball cage 20, and vertical ball restrictor 22.

Locking lever 16 is rotatably supported for pivotable motion about pivot point 24. Locking lever 16 includes arm 26, upper arm 28, and lower arm 30. Upper arm 28 forms edge 32 which engages with ratchet wheel teeth 14 under specific operating conditions, as will be explained in more detail in the following description. Upper arm 28 extends over the upper surface of ball mass 18 and includes a ring-shaped High G actuation rim 34. Lower arm 30 extends to the lower surface of ball mass 18 and includes an upwardly projecting post support 36. The center of gravity (cg) 38 of locking lever 16 is positioned relative to pivot point 24 (to its right as shown in FIG. 1) such that the locking lever is normally urged to rotate in a clockwise direction when the associated vehicle is generally riding on a horizontal road surface, as the elements are illustrated in the figures. Such clockwise pivoting places arm edge 32 into engagement with ratchet wheel teeth 14. Such motion results in engagement with and locking of the associated seat belt retractor. Edge 32 is an example of an engagement feature formed by locking lever 16. Although edge 32 is formed by upper arm 26, it would be possible to utilize other portions of locking lever 16 to form a locking feature which interacts with ratchet wheel teeth 14. Arm 26 is provided to enable the desired positioning of cg 38 of the locking lever 16.

It should be recognized that various approaches for providing a spool lock of a retractor locking system are known. Due to the extremely high forces involved in the operation of a retractor in restraining impact loads acting on seat belt webbing, ratchet wheel 12 may act as an intermediate locking device for the associated retractor. Alternatively, locking lever 16 may force a pivoting locking bar into engagement with spool ratchet wheel 12. In other words, the high rotational loads acting on a retractor spool during occupant restraint may not, in some forms of the invention be directly restrained by the interaction between engagement arm 26 and ratchet wheel 12. Conventionally known mechanical servo-type spool lock engagement systems can be used for retractor inertial sensitive locking systems, such as that of the present invention. These systems allow the highly sensitive inertia locking system to actuate a spool lock mechanism to lock the spool if it has sufficiently high strength. These features are conventionally known and outside the scope of the novel features of the present invention.

Ball mass 18 rests within ball nest 40 formed by ball cage 20. Ball nest 40 is shaped such that ball mass 18 rests in the “normal” position illustrated in FIGS. 1 and 2. In that position, ball mass 18 is resting upon post support 36 which extends upwardly through ball nest aperture 42. This positioning of the components is associated with the normal condition of the components of the locking system 10 in which inertial loads are not acting on the associated vehicle and the locking system and retractor locking is not desired. In this position, the weight of ball mass 18 presses against post support 36 which maintains locking lever 16 in the position shown in FIG. 1, in which arm edge 32 does not engage with ratchet wheel 12.

As best illustrated in FIG. 2, locking lever upper arm actuation rim 34 encircles the upper surface of ball mass 18, but is designed to provide a clearance with the ball mass in the normal position of the ball mass.

Vertical ball restrictor 22 is a feature fixed to ball cage 20 and acts as a “snubber” to restrict upward (Z-axis) motion of ball mass 18. This is intended to provide the reduced Z-axis sensitivity desired for many applications of locking system 10. As mentioned previously, this is commonly required for heavy duty trucks, but the control system 10 of the present invention may be used for other motor vehicle applications. In another embodiment of locking system 10, ball restrictor 22 could be eliminated if reduced Z-axis sensitivity is not required. In the embodiment shown, upper arm actuation rim 34 encircles ball restrictor 22.

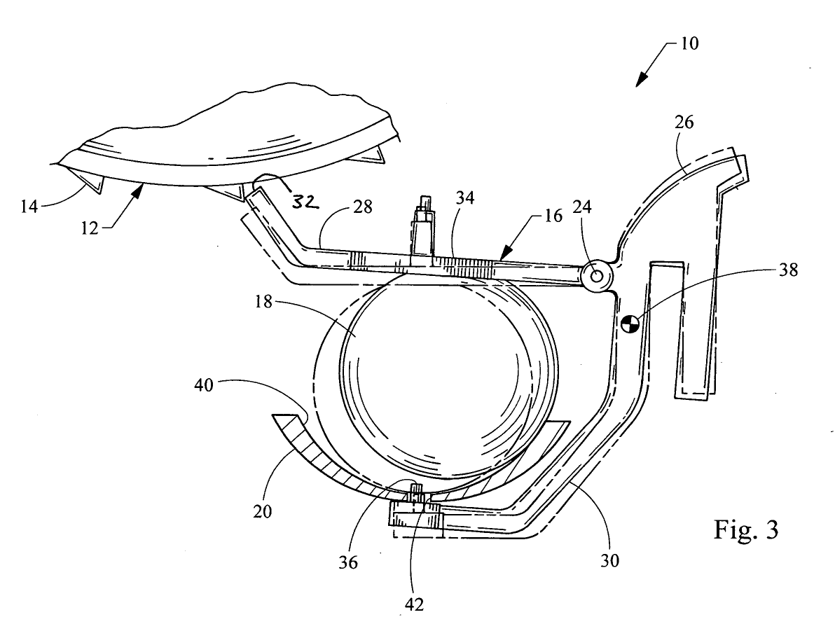

Operation of control system 10 in various conditions will now be described with reference to the Figures. As mentioned previously, FIG. 1 illustrates the orientation of the components in the normal condition in which inertial forces are not acting on the locking system 10 and locking of the associated retractor is not required. In that condition, the weight of ball mass 18 presses against post support 36, maintaining the position of locking lever 16 as illustrated in FIG. 1. In this condition, locking of the retractor does not occur since arm edge 32 does not engage with ratchet wheel 12 which acts as a spool lock. When inertial forces are acting on locking system 10 in a horizontal plane (corresponding to longitudinal or lateral inertial forces on the vehicle), ball mass 18 is urged to move from its normal position to a displaced actuation position. FIG. 3 shows such displacement of ball mass 18. In such an actuation position, post support 36 no longer contacts ball mass 18. This permits locking lever 16 to rotate in a clockwise direction under the influence of the positioning of cg 38 relative to pivot point 24. This action allows locking lever 16 to engage with ratchet wheel 12, locking the retractor.

Ball mass 18 may move vertically off of the ball nest 40 in response to Z-axis (vertical) accelerations. Preferably, ball restrictor 22 is positioned to prevent the ball to move upward sufficiently to allow locking lever 16 to move to its actuation position.

In conditions where high lateral inertial forces are acting on locking system 10 or in a vehicle roll-over situation, a secondary locking behavior is provided by locking system 10. When ball mass 18 is forcibly moved from its normal position to an actuation position such as shown in FIG. 3, its upper surface engages with High G actuation rim 34. The concave shape of ball mass nest 40 causes the ball mass to interact with the actuation rim 34 to force locking lever 16 to the clockwise position, which as stated previously, causes the associated retractor to lock. This locking condition is also provided if the vehicle is inverted, in which case ball mass 18 would rest directly on actuation rim 34 pressing locking lever 16 to an actuation position. Thus, locking system 10 in accordance with the present invention provides two separate and distinct locking modes, one through rotation of locking lever 16 in response to movement of the ball mass 18 away from post support 36 and the second due to direct contact between the ball mass and actuation rim 34. Generally, the first mentioned locking mode would be activated in lower magnitudes of lateral acceleration, i.e. “low g” conditions, whereas the second mentioned locking mode would be activated in relatively higher “high G” conditions.

While the above description constitutes the preferred embodiment of the present invention, it will be appreciated that the invention is susceptible to modification, variation and change without departing from the proper scope and fair meaning of the accompanying claims.

1. A seat belt retractor inertial locking system for a seat belt retractor for locking the retractor through engagement of a spool lock in response to inertial forces acting on the retractor, comprising:
a ball cage forming a ball nest surface;
a ball mass positioned on the nest surface and being displaceable on the nest surface from a normal position to a displaced position in response to inertial forces acting on the ball;
a locking lever mounted for pivoting motion about a pivot point, the locking lever having an engagement feature for engaging with the retractor spool lock, an upper arm and a lower arm, the pivot point positioned relative to the center of gravity of the locking lever such that the locking lever is urged to pivot under the influence of gravity to cause engagement of the retractor engagement feature with the spool lock; and
the locking lever lower arm having a post support which contacts the ball mass in the normal position of the ball mass on the ball nest surface, and the upper arm forming an actuation rim, wherein, in response to inertial loads acting on the ball mass moving the ball mass to the displaced position, the locking lever engagement feature engages the spool lock either through locking modes of the ball mass moving to the displaced position allowing the locking lever to pivot by gravity acting on the center of gravity, or through contact engagement between the ball mass and the actuation rim.

2. The locking system of claim 1 wherein the ball cage nest surface forms an aperture through which the lower arm post support extends in an upward direction to contact the ball mass in the normal position.

3. The locking system of claim 1 further comprising a vertical ball restrictor positioned above the ball mass to restrict vertical movement of the ball mass.

4. The locking system of claim 3 wherein the vertical ball restrictor reduces sensitivity of the locking system to Z-axis accelerations.

5. The locking system of claim 3 further comprising the actuation rim encircling the vertical ball restrictor.

6. The locking system of claim 1 further comprising the locking mode of the ball mass moving to the displaced position allowing the locking lever to pivot by gravity acting on the center of gravity corresponds to a low g actuation condition, whereas the locking mode of the ball mass contacting the actuation rim corresponds to a high g actuation condition.

7. The locking system of claim 1 wherein the engagement feature is an edge formed by the upper arm.

8. A seat belt retractor inertial locking system for a seat belt retractor for locking the retractor through engagement of a spool lock in response to inertial forces acting on the retractor, comprising:
a ball cage forming a ball nest surface;
a ball mass positioned on the nest surface and being displaceable on the nest surface from a normal position to a displaced position in response to inertial forces acting on the ball;
a vertical ball restrictor positioned above the ball mass to restrict vertical movement of the ball mass;
a locking lever mounted for pivoting motion about a pivot point, the locking lever having an engagement feature for engaging with the retractor spool lock, an upper arm and a lower arm, the pivot point positioned relative to the center of gravity of the locking lever such that the locking lever is urged to pivot under the influence of gravity to cause engagement of the retractor engagement feature with the spool lock; and
the locking lever lower arm having a post support which extends upwardly through an aperture of the ball nest and contacts the ball mass in the normal position of the ball mass on the ball nest surface, and the upper arm forming an actuation rim generally encircling the vertical ball restrictor, wherein, in response to inertial loads acting on the ball mass moving the ball mass to the displaced position, the locking lever engagement feature engages the spool lock either through locking modes of the ball mass moving to the displaced position allowing the locking lever to pivot by gravity acting on the center of gravity, or through contact engagement between the ball mass and the actuation rim.

9. The locking system of claim 8 wherein the vertical ball restrictor reduces sensitivity of the locking system to Z-axis accelerations.

10. The locking system of claim 8 further comprising the locking mode of the ball mass moving to the displaced position allowing the locking lever to pivot by gravity acting on the center of gravity corresponds to a low g actuation condition, whereas the locking mode of the ball mass contacting the actuation rim corresponds to a high g actuation condition.

11. The locking system of claim 8 wherein the engagement feature is an edge formed by the upper arm.
